(19) United States
(12) Patent Application Publication
(10) Pub. No.: US 2017/0277613 A1
(43) Pub. Date: Sep. 28, 2017

(54) MULTIPLE MODE TESTING IN A VECTOR MEMORY RESTRICTED TEST ENVIRONMENT

(71) Applicant: QUALCOMM Incorporated, San Diego, CA (US)

(72) Inventors: Anupam Sobti, Bangalore (IN); Sneha Revankar, Bangalore (IN); Kushal Kamal, Bangalore (IN)

(21) Appl. No.: 15/081,093

(22) Filed: Mar. 25, 2016

(51) Int. Cl. G06F 11/263; G06F 11/22

(52) U.S. Cl. CPC G06F 11/263; G06F 11/2273

(57) ABSTRACT

A method and apparatus for testing an electronic device is provided. The method begins when at least one test setup vector for at least one test to be performed is generated. An actual test vector is then generated. The actual test vector may be generated using test results from testing at least one device of known good quality. A delay time parameter determined by waiting for the test controller to complete the test. After the delay time parameter has been determined, at least one test result is output as a test signature. The test signature and the delay time parameter may used to call the test and provide for counter-based delay independent memory testing. The apparatus includes a test controller and a vector memory in communication with the test controller and at least one clock in communication with the test controller and a power supply.

### BACKGROUND

Field

The present disclosure relates generally to testing electronic devices. More specifically the present disclosure related to methods and apparatus for multiple mode testing in a vector memory restricted test environment.

Background

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipment, and similar terms.

These wireless communication devices typically use a system-on-chip (SoC) to provide many of the functions of the device. A SoC is an integrated circuit that combines all components of a computer or other electronic system on a single chip. The SoC device may contain digital, analog, mixed-signal, and radio frequency (RF) functions on a single substrate. SoCs are used widely due to their low power consumption.

A SoC may consist of a microcontroller or digital signal processor (DSP) core, memory blocks including a selection of ROM, RAM, EEPROM, and flash memory, as well as timing sources. The timing sources may include oscillators and phase-locked loops (PLL). Peripherals, including counter-timers, real-time timers, and power-on reset generators may also be incorporated. A wide variety of external and internal interfaces including analog-to-digital (ADC), digital-to-analog converters (DAC), voltage regulators and power management circuits are also typically included in a SoC. The desired performance of the end device may result in different mixes of the above functions to be included in the SoC. The SoC also includes a bus system for connecting the various functional blocks.

Testing a SoC may be complex and time consuming. During testing of an SoC different frequencies must be tested. Each frequency tested has a different specification. All operating frequencies must be tested to ensure that the SoC or other device performs as intended in all modes. In addition, the memory of the SoC must be tested. When the memory of the SoC is tested the tests are stored in a memory present on the test apparatus. Limits on this memory may increase testing costs. However, due to restricted vector memory this test coverage may be sacrificed when testers with lower limits of vector memory are used to conduct tests. In addition, in some cases cross-corner tests cannot be integrated into the test flow due to the lower vector memory limit in some testers.

There is a need in the art for a method and apparatus for multiple mode testing in a vector memory restricted environment.

### SUMMARY

Embodiments described herein provide a method for testing an electronic device. The method begins with the generation of at least one test setup vector for at least one test to be performed. An actual test vector is then generated. The actual test vector may be generated using test results obtained from testing at least one device of known good quality. A delay time parameter is then determined. The delay time parameter may be determined by waiting for the test controller to complete the test. After the delay time parameter has been determined, at least one test result is output as a test signature. An additional delay parameter may also be added to take into account any variations across chips that may be present when different chip manufacturing processes are used. The test signature and the delay time parameter may used to call the test.

An additional embodiment provides an apparatus for testing an electronic device having a test controller and a vector memory in communication with the test controller. In addition, the apparatus may include at least one clock in communication with the test controller and a power supply.

A further embodiment provides an apparatus for testing an electronic device. The apparatus provides: means for generating at least one test setup vector for at least one test to be performed; means for generating at least one actual test vector; means for determining a delay time parameter; means for outputting at least one test result as a test signature; and means for calling the at least one test signature to initiate at least one test.

A yet further embodiment provides a non-transitory computer-readable medium containing instructions, which when executed cause a processor to perform the steps of: generating at least one test setup vector for at least one test to be performed; generating at least one actual test vector; determining a delay time parameter; outputting at least one test result as a test signature; and calling the at least one test signature to initiate at least one test.

### BRIEF DESCRIPTION OF THE DRAWINGS

FIG. 1 is a block diagram of a SoC, in accordance with embodiments disclosed herein.

FIG. 2 illustrates a typical test flow for an electronic device, in accordance with embodiments described herein.

FIG. 3 is a flowchart of a method of test setup separation, in accordance with embodiments described herein.

FIG. 4 is a flowchart of a method of delay optimization, in accordance with embodiments described herein.

FIG. 5 is a flowchart of a method of delay optimization using a modified test controller, in accordance with embodiments described herein.

FIG. 6 is a flowchart of a method of multiple mode testing in a vector memory restricted environment, in accordance with embodiments described herein.

FIG. 7 is a block diagram of a test completion prediction apparatus, in accordance with embodiments described herein.

FIG. 8 is a block diagram of implementing test completion prediction in a SoC, in accordance with embodiments described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps or blocks of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps, blocks, or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

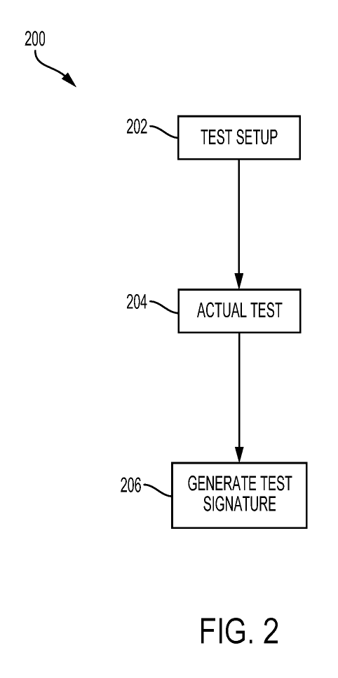

Further, it should be appreciated that modules and/or other appropriate means for performing the methods and techniques described herein, such as those illustrated by FIGS. 2-6, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Embodiments described herein relate to a method and apparatus for multiple mode testing in a vector memory restricted environment. Embodiments described below provide a three part solution: test setup separation, delay optimization using a parameter in vectors, and assembling an optimized flow based on per mode fallout. Some embodiments allow for testing adjustments to be made on the fly.

A test setup enables the clocks and power to bring up the intended test block. These test blocks may be small size, but may vary across testing modes. In the actual test, a parameter for the delay time for the test to be completed is determined. This may be done by taking the maximum memory and the slowest frequency independent of the operational modes. In the test setup phase separate vectors are generated for the test setup and the actual test stages. The actual test vectors are used across frequency modes. Different test setups are generated for different frequency modes. The frequencies of the frequency test mode used for testing may be predetermined. That actual test stage is independent of frequency when used with a parameter. Only the parameter may be varied across the frequencies being tested.

Delay optimization begins with the instructions for starting the test. First the controller finishes the test. During this wait time while the controller is finishing the test optimization may occur. The wait time may be altered depending on the mode being tested. The parameters are then obtained before testing and are based on tests of known good electronic devices. This allows the same test vector to be used with multiple frequencies.

A further embodiment permits the wait time to be set, as a delay parameter, to a fixed number of clock cycles instead of a fixed period of time. This assists in testing independent of the clock frequency. In an optimized test flow different test suites call the same pattern in the pattern map file, but with different parameters, thus reducing the amount of vector memory needed for storing the test vectors. These embodiments may be extended to enable memory repair of different modes using the same repair vectors. In addition, these embodiments may also be used to test voltage dip and voltage data retention.

A SoC is an integrated circuit that combines all components of a computer or other electronic system on a single chip. It may contain digital, analog, mixed-signal, and radio frequency (RF) functions. A SoC may consist of: a microcontroller or digital signal processor (DSP) core; memory blocks, including a selection of read-only memory (ROM), random access memory (RAM), electrically erasable programmable read-only memory (a type of non-volatile memory), and flash memory; timing sources including oscillators and phase-locked loops (PLL); peripherals including counter-timers, real-time timers, and power-on or reset generators; external interfaces; analog interfaces including analog to digital converters (ADC), digital to analog converters (DAC); voltage regulators; and power management circuits. A bus connects these blocks within the SoC.

Testing the SoCs may be an important part of the manufacturing process. Automated test equipment (ATE) is used to perform tests on a device, known as the device under test (DUT) using automation to quickly perform measurements and evaluate test results. An ATE may be a simple computer-controlled digital multimeter, or may be a more complex system with many test instruments capable of testing and diagnosing faults in SoCs. ATE systems are designed to reduce the amount of test time needed to verify that a particular electronic device functions correctly, or to quickly find the faults before the device is installed in an end product, such as a wireless device. An ATE system may consist of a master controller (often a computer) that synchronizes one or more capture instruments.

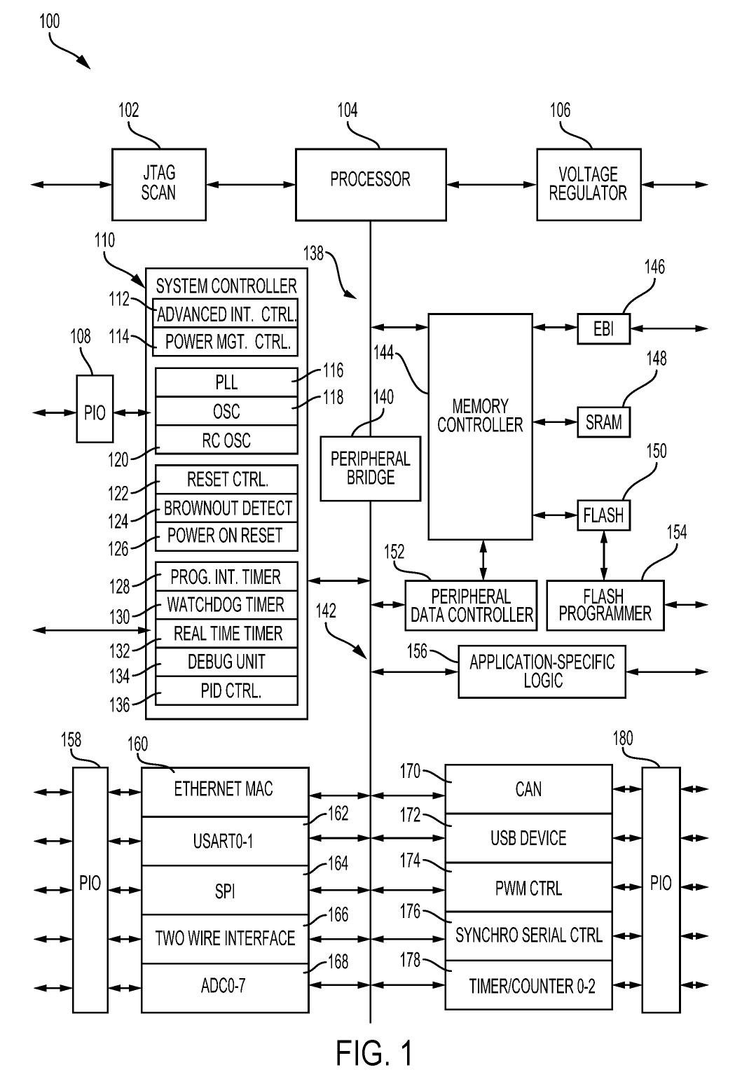

FIG. 1 illustrates a SoC, 100. The assembly 100 includes joint test action group (JTAG) scan device 102, which receives input signals for scanning. These signals are scanned before being sent to the Acorn Reduced Instruction Set Computing (RISC) Machine (ARM) processor 104. The ARM processor 104 may also send input to JTAG scan device 102, which in turn may provide output. The ARM processor also interfaces with voltage regulator 106. While an ARM processor is illustrated, the SoC may include any type of suitable processor to carry out the functions needed. The SoC 100 may also incorporate a first peripheral input/output interface (PIO) 108. This PIO 108 interfaces with a system controller 110. System controller 110 may incorporate an advanced interface controller 112, a power management controller 114, a phase locked loop (PLL) 116, an oscillator 118, a resistor-capacitor (RC) oscillator 120, a reset controller 122, a brownout detector 124, a power on reset device 126, a program interrupt timer 128, a watchdog timer 130, a real time timer 132, a debug unit 134, and a proportional/integral/derivative (PID) controller 136. All of the devices under the control of system controller 110 interface through the PIO.

The ARM processor 104 interfaces with peripheral bridge 140, which also provides input and output interface with the system controller 110. The peripheral bridge communicates with multiple components using an application peripheral bus (APB) 142. An internal bus 138 operates in conjunction with the peripheral bridge 140 to communicate with additional devices within the SoC 100. The internal bus 138 may be an application specific bus (ASP) or an application handling bus (AHB). Memory controller 140 interfaces with ARM processor 104 using internal bus 138. The memory controller 140 also communicates with the external bus interface (EBI) 146. Memory controller 140 is also in communication with static random access memory (SRAM) 148, and flash memory 150. Flash memory 150 is in communication with flash programmer 154. The memory controller 144 is also in communication with peripheral data controller 152. Additional application specific logic 156 communicates with the internal bus 138 and may also have external connections. A second PIO 158 provides communication with an Ethernet medium access control (MAC) 160. The second PIO 158 also communicates with a universal asynchronous receiver/transmitter 162, a serial peripheral interface (SPI) 164, a two wire interface 166, and an analog to digital converter 168. These devices and interfaces connect through internal bus 138 with a controller area network bus (CAN) 170, a universal serial bus (USB) devices 172, a pulse width modulator (PWM) controller 174, a synchro serial controller 176, and a timer/counter 178. These devices, CAN 170, USB device 172, PWM controller 174, synchro serial controller 176 and timer/counter 178 interface with third PIO 180, which provides external input and output. While these elements are typical of many SoCs, other devices may be incorporated, and some may not be included.

Testing suites provide an efficient way to test SoCs and other electronic devices. Many test controllers incorporate vector memory as part of the device. A conventional memory may be envisioned as an array of cubbyholes, each of which contains a piece of information. Each cubbyhole has a unique name, called either address or location. Often memory systems provide two primitive operations: one that fetches data stored in a specified location and another that assigns new data to a specified location. Memory addresses may be incremented to support sequential access to some set of cubbyholes. More generally, many important data operations require that memory addresses be treated as data, which can be stored in memory location and manipulated in machine registers. The representation of list structure is an application of such address arithmetic.

To model memory structures, a new kind of data structure, called a vector may be used. Abstractly, a vector is a compound data object whose individual elements may be accessed by means of an integer index in an amount of time that is independent of the index. In order to describe memory operations two primitive scheme procedures may be used: (vector-ref vector n) returns the n^{th} element of the vector, and (vector-set\vector n value) sets the n^{th} element of the vector to the designed value. This access may be implemented through the use of address arithmetic to combine a base address that specifies the beginning location of a vector in memory with an index that specifies the offset of a particular element of the vector.

Vectors may be used to implement the basic pair structures required for a list structured memory. The memory may be divided into two vectors. This list structure may be represented as follows: a pointer to a pair is an index into the two vectors. The first item of the pair is the entry in the first vector with the designated index, and the second item in the pair is the entry in the second vector with the designated index. Also needed is a representation for objects other than pairs (such as numbers and symbols), and a way to distinguish one type of data from another. This may be done with the typed pointer, which extends the notion of “pointer” to include information on data type. The data type enables the system to distinguish a pointer to a pair (which consists of the “pair” data type and an index into the memory vectors) from pointers to other types of data. Two data objects are considered to be the same if their pointers are identical.

A pointer to a number, which may designate a specific test to perform, may consist of a type indicating numeric data together with the actual representation of the number. A symbol may be represented as a typed pointer that designates a sequence of the characters that form the symbol's printed representation. A reader views the symbols and keeps an array, known the object array (obarray), of all of the symbols that have been encountered. New symbols may be added to the obarray as they are encountered. Using these techniques, each primitive list operation of a register machine may be replaced with one or more primitive vector operations. These vector operations allow efficient storage of complex test patterns, however, vector memory limits may seriously affect the number of test vectors that may be stored.

FIG. 2 is a flowchart of a test setup. This test setup process may be used as the basis for a wide variety of tests, including frequency tests. In the test setup process 200 the process begins with block 202. In block 202 a test setup enables the clocks and power to the intended test block. For a frequency test this may include enabling the clocks, power, and transmit and receive sections of the SoC. Test setup is usually a small size memory item and may vary with the mode being tested. In block 204 an actual test is performed and the test time is noted. The actual test occurs in this block. A parameter is defined so that the delay time for the test may be determined. This may require the maximum virtual memory and may be independent of the mode being tested. Following the actual test, in block 206 a signature is generated. The test results are output in the form of a signature. The test signature is generated after completion of the actual test and represent the test results. The test signature uses less virtual memory compared with the actual test bloc of 202. The test signature is independent of the frequency when used with a parameter. Only the parameter varies across the frequency. It should be noted that the actual test vectors, as defined in block 202 may be used across multiple frequencies.

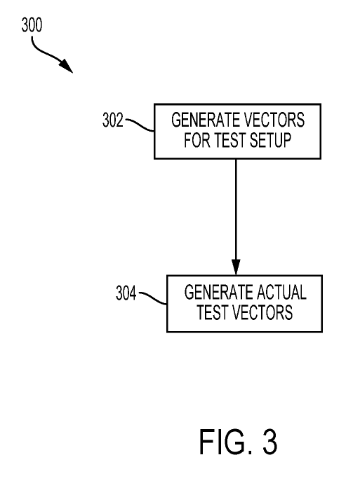

FIG. 3 illustrates the test setup separation process 300. In block 302 vectors for test setup are generated. In block 304 actual test vectors are generated. The test setup vectors are separate from the actual test vectors. The actual test vectors generated in block 304 are used across frequency modes. The test setup vectors generated in block 302 are generated for the different frequency modes planned to be tested. A different test setup vector is needed for each frequency mode to be tested.

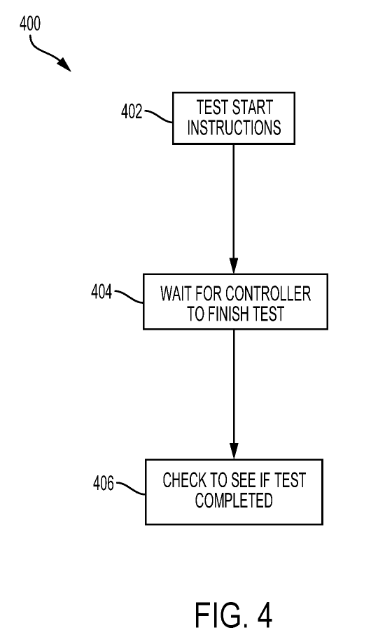

FIG. 4 is a flowchart of delay optimization, in accordance with embodiments described herein. The process 400 begins with block 402, where the test begin instructions are initiated. In block 404 the process waits for the test controller to finish the test. It is here that the optimization occurs. The “wait” time is altered depending on the mode being tested. These parameters are obtained prior to the test and are based on prior testing of a set of known good devices. These known good devices are used to establish a baseline set of parameters and test results. This use of known good device test results allows the same test vector to be used with multiple frequencies. In block 406 a check is made to determine if the test has been completed.

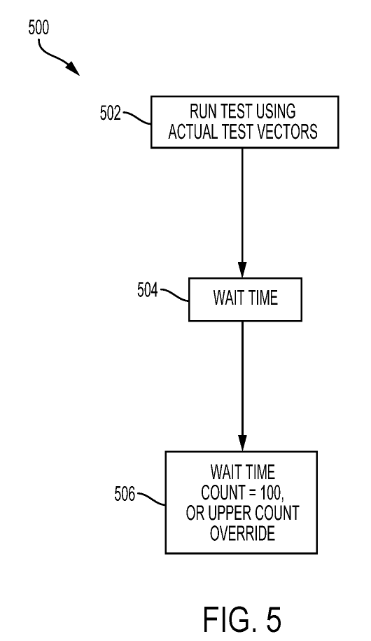

FIG. 5 is a flowchart of delay optimization in accordance with embodiments described herein. The method 500 provides for delay optimization using a change in the design of the test controller. In block 502 a test to be optimized is run using actual test vectors. Then in block 504 a delay parameter, such as wait time, is determined. In block 506 the process automatically waits for the test to complete with an upper limit count of N, where N is a large integer such as 100, unless an upper limit count override has been specified by the user. An upper count override may be set by the user and may be based on frequency. For example, a lower frequency may require a longer wait time to allow the test to be completed. The wait time flexibility permits the same test vector to be used with a wide variety of frequencies. In a further embodiment, the wait time may be set to a fixed number of clock cycles instead of a fixed amount of time. This embodiment allows clock independent testing.

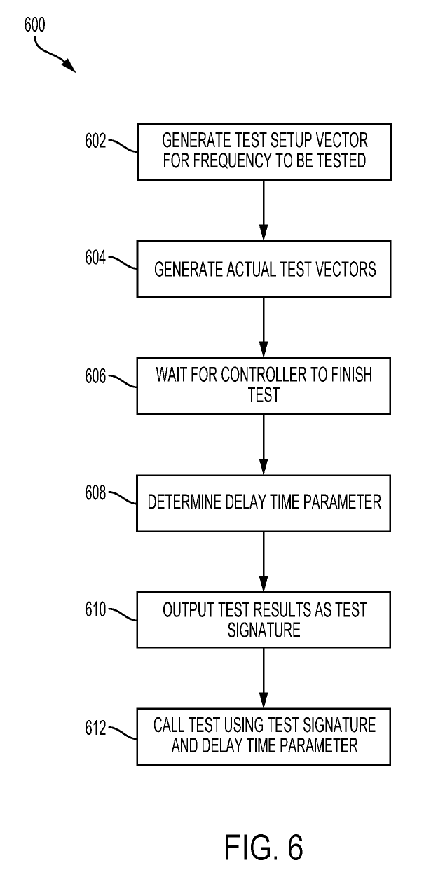

FIG. 6 is a flowchart of a method of multiple mode testing in a vector memory restricted environment. The method 600, begins in block 602 where test setup vectors are generated for each frequency to be tested. The test setup vectors enables the clocks and the power to bring up the intended test block in the test controller. These test setup vectors may be small size, however, the size may vary across the testing modes. Different test setups may be generated for different frequency modes. Next, in block 604 actual test vectors are generated. These actual test vectors may be created by testing a known good set of electronic devices and noting the values of interest. The actual test vectors are used in testing across multiple frequencies. In block 606 the method waits for the controller to finish the test. Delay optimization provides for altering the wait time depending on the mode being tested. Then in block 608 the delay time parameter is determined. This delay time parameter is determined during the actual test, when the actual test vectors are generated. The delay time parameter is determined by taking the maximum vector memory independent of the operational modes. Then in block 610 the test results are output as a test signature. The test signature requires less vector memory compared with the amount of memory that would be required using separate actual test vectors for the different frequency modes to be tested. The actual test stage is independent of frequency when used with the delay time parameter. Only the delay time parameter is varied across the frequencies being tested, which allows the same test vector to be used with multiple frequencies. Using the same test vectors reduces the amount of vector memory needed. Finally, in block 612, when testing is performed on a lot of electronic devices the test is called by the test controller using the test signature and the delay time parameter.

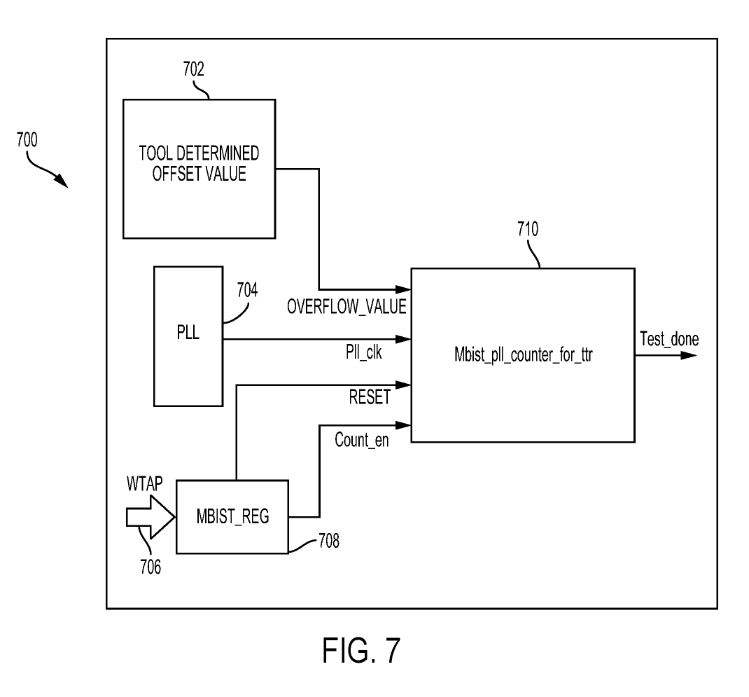

FIG. 7 is a block diagram of a test completion prediction (TCP) apparatus, in accordance with embodiments described herein. The TCP assembly 700 includes a tool determined offset value, block 702. The tool determination offset value is input as an overflow value to the memory built-in self test (MBIST) phase locked loop (PLL) counter 710. Phase locked loop (PLL) 704 provides a PLL clock input to the MBIST PLL counter 710. A wireless test access protocol 706 provides input to MBIST register 708. The MBIST register 708 sends a count enable signal and a reset signal to MBIST PLL counter 710. Once MBIST PLL counter 710 has received the inputs, a test done signal is output.

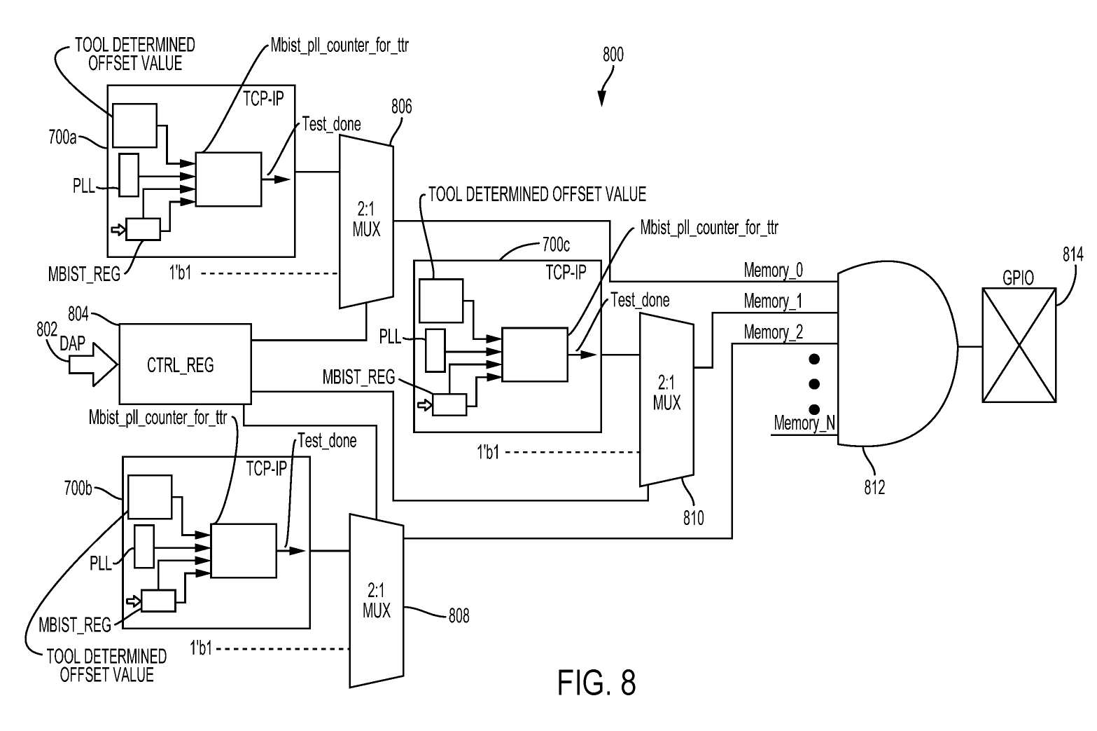

FIG. 8 is a block diagram of an implementation of a TCP apparatus 700 into a SoC. The SoC 800 includes three TCP 700 blocks incorporated into the assembly. The TCP 700a is connected to 2:1 multiplexer 806. TCP 700a provides a test done indication to multiplexer 806. Directory access protocol (DAP) 802 provides input to control register 804. Control register 804 provides input to 2:1 multiplexers 806, 808, and 810 control selecting the TCP-IP input or 1′b1 input for each multiplexer 806, 808, and 810. TCP 700b provides input to 2:1 multiplexer 808. TCP 700c provides input to 2:1 multiplexer 810. Each multiplexer 806, 808, and 810 also receives a 1′b1 input. Multiplexer 806 outputs data to memory 0 input on AND gate 812. Multiplexer 810 outputs data to memory 1 input on AND gate 812. Multiplexer 808 outputs data to memory 2 input on AND gate 812. AND gate 812 may accept additional inputs depending on the number of memories, as shown by the memory N input. AND gate 812 provides a high output after the AND logic operation to general purpose input/out 814 when all inputs are high.

A further embodiment allows the delay time or wait time to be set to a fixed number of clock cycles instead of a predetermined period of time. This may assist when it is desirable to test independent of clock frequency. In the optimized flow embodiment, different test suites may call the same pattern in the pattern map file with different delay time parameters. The embodiments described herein may also be extended to memory repair of the different modes, using the same test vectors. The test vectors may also be used to test voltage dip and voltage data retention.

It is understood that the specific order or hierarchy of blocks in the processes disclosed is an illustration of exemplary approaches. Based upon design preferences, it is understood that the specific order or hierarchy of blocks in the processes may be rearranged. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for testing an electronic device, comprising:
generating at least one test setup vector for at least one test to be performed;
generating at least one actual test vector;
determining a delay time parameter;
outputting at least one test result as a at least one test signature; and
calling the at least one test signature to initiate at least one test.

2. The method of claim 1, wherein the generating at least one actual test vector uses test results from testing performed on at least one known good electronic device.

3. The method of claim 1, wherein the delay parameter varies with a frequency being tested.

4. The method of claim 3, wherein the delay parameter is a predetermined amount of time.

5. The method of claim 3, wherein the delay parameter is a predetermined number of clock cycles.

6. The method of claim 1, wherein the at least one test setup vector contains clock and power settings for the at least one test to be performed.

7. The method of claim 1, wherein at least one actual test vector is used in testing multiple frequencies.

8. An apparatus for testing an electronic device, comprising:
a test controller; and
a vector memory in communication with the test controller.

9. The apparatus of claim 8, wherein the vector memory stores test signatures.

10. The apparatus of claim 8, further comprising:
at least one clock in communication with the test controller; and
a power supply.

11. The apparatus of claim 9, wherein the test signatures stored in the vector memory contain one or more delay time parameters.

12. The apparatus of claim 11, wherein the at least one clock is responsive to the one or more delay time parameters.

13. An apparatus for testing an electronic device, comprising:
means for generating at least one test setup vector for at least one test to be performed;
means for generating at least one actual test vector;
means for determining a delay time parameter;
means for outputting at least one test result as a test signature; and
means for calling the at least one test signature to initiate at least one test.

14. The apparatus of claim 13, wherein the means for generating at least one actual test vector uses test results from testing performed on at least one known good electronic device.

15. The apparatus of claim 13, wherein the means for determining a delay time parameter varies the delay time parameter with a frequency being tested.

16. The apparatus of claim 15, wherein the means for determining a delay time parameter determines the delay time parameter as a predetermined amount of time.

17. The apparatus of claim 15, wherein the means for determining a delay time parameter determines the delay time parameter as a predetermined number of clock cycles.

18. The apparatus of claim 13, wherein the means for generating at least one test setup vector determines clock and power settings for the at least one test to be performed.

19. The apparatus of claim 13, wherein the means for determining at least one actual test vector determines the at least one actual test vector for testing a predetermined frequency.

20. The apparatus of claim 16, wherein the means for

21. A non-transitory computer-readable medium containing instructions, which when executed by a processor cause a processor to perform the steps of:
generating at least one test setup vector for at least one test to be performed;
generating at least one actual test vector;
determining a delay time parameter;
outputting at least one test result as a test signature; and
calling the at least one test signature to initiate at least one test.

22. The non-transitory computer-readable medium of claim 21, wherein the instructions for generating at least one actual test vector uses test results from testing performed on at least one known good electronic device.

23. The non-transitory computer-readable medium of claim 21, wherein the instructions for determining the delay parameter vary the delay parameter with a frequency being tested.

24. The non-transitory computer-readable medium of claim 23, wherein the instructions for determining the delay parameter cause the delay parameter to be a predetermined amount of time.

25. The non-transitory computer-readable medium of claim 23, wherein the instructions for determining the delay parameter cause the delay parameter to be a predetermined number of clock cycles.

26. The non-transitory computer-readable medium of claim 21, wherein the instructions for generating at least one test setup vector contain clock and power settings for the at least one test to be performed.

27. The non-transitory computer-readable medium of claim 21, wherein the instructions for generating at least one actual test vector cause the at least one actual test vector to be used in testing multiple frequencies.
